(19) United States
(12) Patent Application Publication
(10) Pub. No.: US 2026/0348566 A1
(43) Pub. Date: Nov. 5, 2026

(54) LIGHT STRIP CONNECTOR

(71) Applicants: SUZHOU OPPLE LIGHTING CO., LTD., Suzhou City (CN); OPPLE LIGHTING CO., LTD., Shanghai (CN)

(72) Inventor: Liuhua XIAO, Suzhou City (CN)

(73) Assignees: SUZHOU OPPLE LIGHTING CO., LTD., Suzhou City (CN); OPPLE LIGHTING CO., LTD., Shanghai (CN)

(21) Appl. No.: 19/722,541

(22) Filed: Jun. 26, 2026

Related U.S. Application Data
(63) Continuation of application No. PCT/CN2024/143211, filed on Dec. 27, 2024.

(30) Foreign Application Priority Data
Dec. 29, 2023 (CN) 202323662544.8

(51) Int. Cl. F21V 21/005; F21S 4/20; F21V 23/06

(52) U.S. Cl. CPC F21V 21/005; F21S 4/20; F21V 23/06

(57) ABSTRACT

A light strip connector for connecting light strips includes a cover part, a base, and an electrical connection structure accommodated between the cover part and the base. The cover part and the base cooperatively define an accommodating space and are movable relative to each other to allow insertion of light strips from opposite sides of the base. The electrical connection structure includes a body and a conductive terminal fixed to the body, the conductive terminal being configured to electrically connect adjacent light strips. Limiting parts are disposed on opposite side walls of the base, and matching parts are disposed on the body. The limiting parts cooperate with the matching parts to limit and fix the electrical connection structure relative to the base.

### CROSS-REFERENCE TO RELATED DISCLOSURES

This disclosure is based upon and claims the priority of PCT patent disclosure No. PCT/CN2024/143211 filed on Dec. 27, 2024, which claims priority to the Chinese patent disclosure No. 202323662544.8 filed on Dec. 29, 2023, the entire contents of which are hereby incorporated by reference herein for all purposes.

### TECHNICAL FIELD

The present disclosure relates to a light strip connector, which belongs to the technical field of lighting fixtures.

### BACKGROUND

With the rapid development of the LED lighting industry and the gradual improvement of people's living standards, flexible LED light strips have been applied increasingly wide. After a light strip is cut, quick-connect terminals are required to realize electrical connection.

### SUMMARY

The present disclosure provides a light strip connector for electrically connecting adjacent light strips.

Accordingly, the light strip connector includes a cover part, a base, and an electrical connection structure accommodated between the cover part and the base. The electrical connection structure includes a body and a conductive terminal configured to electrically connect bonding pads of the adjacent light strips. Limiting parts are provided on opposite side walls of the base, and matching parts are provided on the body of the electrical connection structure. The limiting parts cooperate with the matching parts to secure the electrical connection structure relative to the base, thereby maintaining electrical contact between the conductive terminal and the light strips. The cover part and the base are movable relative to each other to facilitate insertion and clamping of the light strips.

It is to be understood that both the foregoing general description and the following detailed description are exemplary and explanatory only and are not restrictive of the present disclosure.

### BRIEF DESCRIPTION OF DRAWINGS

FIG. 1 is a schematic structural view of a light strip connector matched with a light strip of the present disclosure.

FIG. 2 is a schematic structural view of the light strip connector in FIG. 1 in an open state.

FIG. 3 is a schematic structural view of the light strip in FIG. 2.

FIG. 4 is a schematic structural view of a first example of the light strip connector shown in FIG. 2.

FIG. 5 is a cross-sectional view of the light strip connector shown in FIG. 4.

FIG. 6 is a partial enlarged view of the circled area A in FIG. 5.

FIG. 7 is an exploded view of the light strip connector shown in FIG. 4.

FIG. 8 is a schematic structural view of the base and the cover part in FIG. 7.

FIG. 9 is a schematic view of the electrical connection structure in FIG. 7.

FIG. 10 is a schematic structural view when the electrical connection structure shown in FIG. 9 is inserted into the light strip.

FIG. 11 is a schematic structural view of a second example of the light strip connector in FIG. 2.

FIG. 12 is an exploded view of the light strip connector shown in FIG. 11.

FIG. 13 is a schematic view of FIG. 12 from another perspective.

FIG. 14 is a schematic view of the electrical connection structure in FIG. 13.

FIG. 15 is a schematic structural view when the electrical connection structure shown in FIG. 14 is inserted into the light strip.

### DETAILED DESCRIPTION

To make the objectives, technical solutions and advantages of the present disclosure clearer, the present disclosure will be described in detail below with reference to the accompanying drawings and examples.

The terminal clamping force of existing light strip connectors is entirely provided by the cover plate. However, the cover plate is prone to deformation after long-term exposure to heat or compressive stress, resulting in loss of clamping force and subsequent connection failure. This problem is especially prominent for flip-type terminals, where the cover plate is only latched to the base on one side. Under prolonged thermal and compressive loads, the cover plate easily deforms and loses its clamping force on the terminals, which impairs connection reliability.

In view of the above drawbacks, it is indeed necessary to improve the existing light strip connectors to solve the above-mentioned problem.

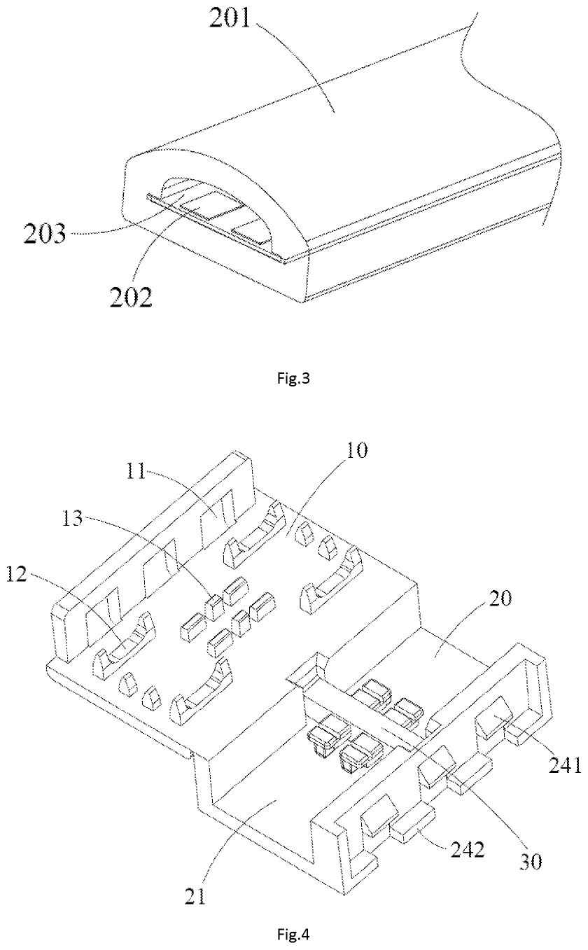

As shown in FIG. 1 to FIG. 3, the present application discloses a light strip connector 100 for connecting two adjacent light strips 200. The light strip 200 includes a light strip main body 201 and a bonding pad 202 fixed inside the light strip main body 201. An accommodating space 203 is formed inside the light strip main body 201, and the bonding pad 202 is fixed within the accommodating space 203, so that electrical connection between the light strip connector 100 and the light strip 200 can be realized when the light strip connector 100 is inserted into the accommodating space 203.

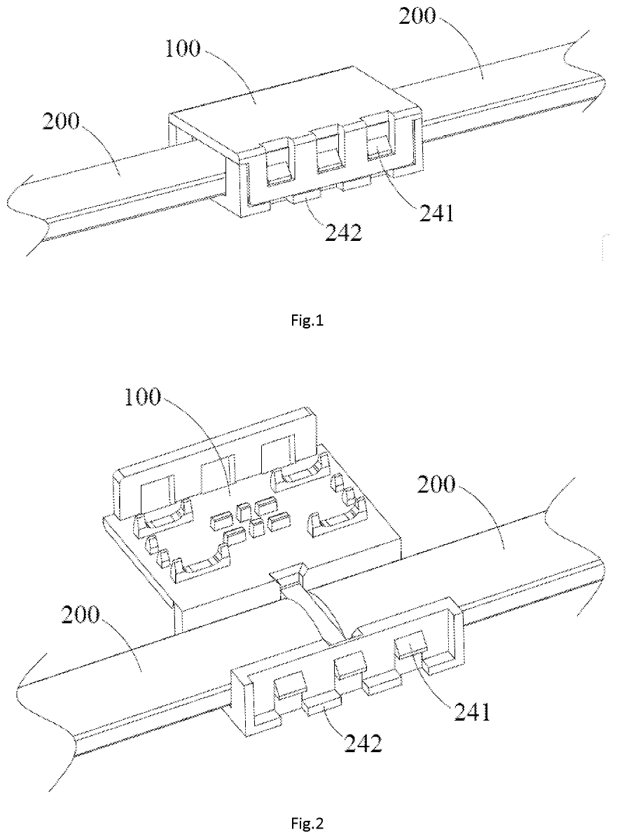

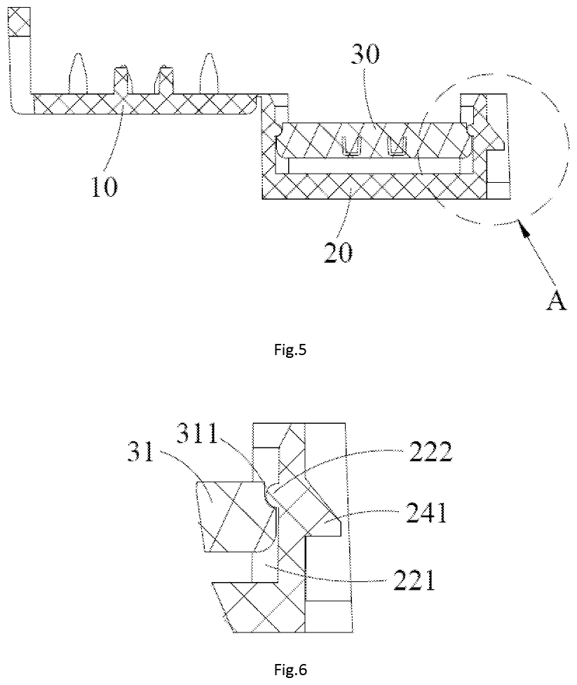

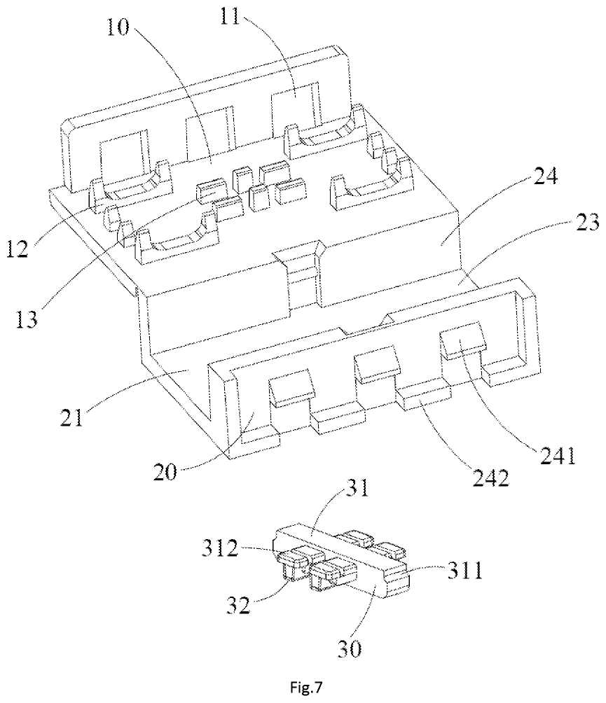

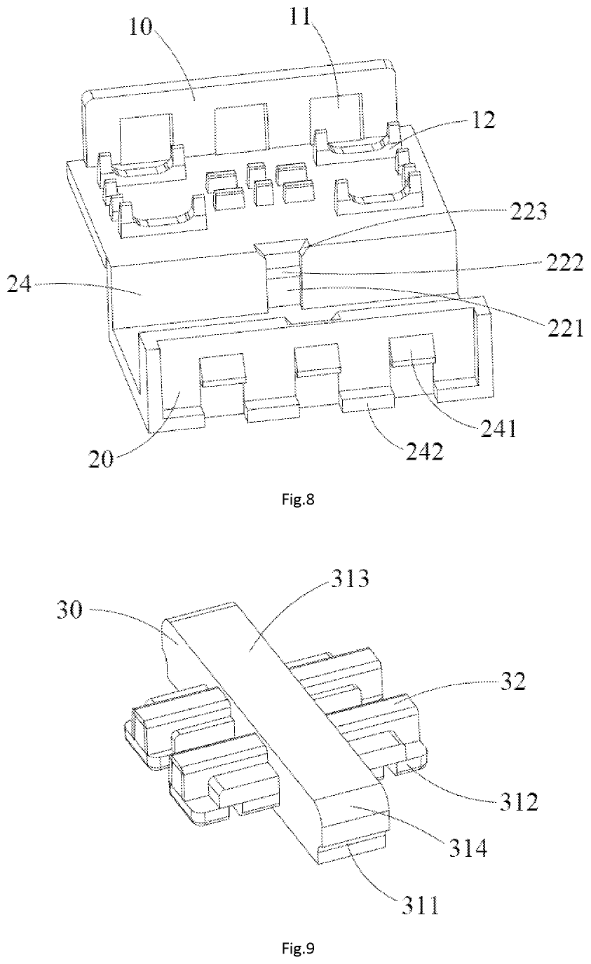

With reference to FIG. 4 to FIG. 8 in combination with FIG. 2, the light strip connector 100 includes a cover part 10, a base 20 and an electrical connection structure 30. The cover part 10 is connected to the base 20 to form an accommodating space 21 therein. The cover part 10 and the base 20 can be movable to open the accommodating space 21, allowing the light strips 200 to enter from both sides of the base 20, and the cover part 10 and the base 20 can clamp the light strips 200 therebetween. Specifically, the electrical connection structure 30 is accommodated inside the accommodating space 21. An end of the accommodating space 21 is of an open structure to facilitate installation of the electrical connection structure 30 and the light strip main body 201 into the accommodating space 21. The electrical connection structure 30 includes a body 31 and a conductive terminal 32 fixedly connected to the body 31. The conductive terminal 32 is configured for electrical connection with the bonding pad 202. Preferably, the conductive terminal 32 is fixed on the body 31 and exposed on both sides of the body 31 to form electrical communication with the light strips 200 entering from two sides of the base 20.

A rotating structure is formed between the cover part 10 and the base 20 with a rotation range of 0° to 180°. The cover part 10 and the base 20 can open or close the accommodating space 21 via the rotating structure, which facilitates placement of the light strips 200, facilitating operation. In an example, the rotating structure is a thin plate, preferably, a plastic thin plate. In other examples, the rotating structure may be a rotating shaft or other elements capable of realizing rotation, and it particularly can be set according to actual application requirements, which is not limited.

In this example, both the material of the cover part 10 and the base 20 is plastic to enhance plasticity of the product. The cover part 10, the thin plate and the base 20 are integrally injection-molded, which is conducive to mass production for manufacturers with high production efficiency and is also convenient for users to operate.

The base 20 includes a bottom wall 23 and side walls 24 disposed on two sides of the bottom wall 23. The bottom wall 23 and the side walls 24 enclose the accommodating space 21 for accommodating the light strips 200. A first buckle part 241 is disposed on an outer wall surface of the side walls 24. The cover part 10 is configured to be matched with the base 20 to fix the light strips 200 inside the accommodating space 21. The cover part 10 is provided with a second buckle part 11 matched with the first buckle part 241, so that the cover part 10 can be fixed onto the base 20 through mutual buckling matching between the first buckle parts 241 and the second buckle parts 11.

In this example, the first buckle part 241 is a protrusion part, and the second buckle part 11 is a recess matched with the protrusion part. Certainly, in other examples, the first buckle part 241 may be recess and the second buckle part 11 may be a protrusion part matching the recess; alternatively, the first buckle part 241 and the second buckle part 11 may adopt other mutually matched structures, which are not limited herein.

A plurality of first abutting parts 12 are disposed on the inner wall surface of the cover part 10 to abut and compress the light strips 200, so that the light strips 200 are firmly fixed within the accommodating space 21. Preferably, two groups of the first abutting parts 12 are provided and disposed at two ends of the cover part 10 respectively to fix two adjacent light strips 200. A second abutting part 13 located between the two groups of first abutting parts 12 is further disposed on the inner wall surface of the cover part 10. The second abutting part 13 is configured to abut and tightly compress the electrical connection structure 30, so that the electrical connection structure 30 is stably fixed in the accommodating space 21.

Further, a plurality of reinforcing ribs 242 are disposed on the outer wall surface of the side walls 24, which can prevent users from disassembling the product by hand and thus avoid the risk of electric shock.

Considering that the cover part 10 is prone to deformation after long-term exposure to heat or compressive stress, resulting in loss of clamping force and further failure of electrical connection between the electrical connection structure 30 and the light strips 200. Thus, the present application improves both the base 20 and the electrical connection structure 30, so that the electrical connection structure 30 is tightly matched with the base 20 to establish electrical connection between the electrical connection structure 30 and the light strips 200. Even if the cover part 10 loses clamping force, it does not affect the electrical connection between the electrical connection structure 30 and the light strips 200, which greatly improves the reliability of electrical connection.

Specifically, limiting parts are disposed on opposite side walls 24 of the base 20, and matching parts are correspondingly disposed on the body 31 of the electrical connection structure 30. Thus, through cooperation between the limiting parts and the matching parts, the electrical connection structure 30 can be limited and fixed in the base 20 at least along the thickness direction of the light strip connector 100.

As shown in FIG. 5 to FIG. 9, in the first example of the present application, the limiting part includes a positioning groove 221 disposed on the side wall 24 of the base 20 and a limiting post 222 fixed in the positioning groove 221. The matching part is a recess 311 disposed at the top edge of the body 31. When the electrical connection structure 30 is assembled into the base 20, the limiting post 222 is limitedly accommodated in the recess 311, thereby limiting the electrical connection structure 30 within the accommodating space 21.

Specifically, the positioning groove 221 is recessed inwardly on the side wall 24 of the base 20, and the limiting post 222 connects two opposite inner wall surfaces of the positioning groove 221. A guiding surface 223 is disposed on a side of the positioning groove 221 close to the cover part 10, and the limiting post 222 is fixed at a certain distance below the guiding surface 223. The body 31 includes a first body part 312 and a second body part 313 perpendicular to each other, and the second body part 313 is disposed perpendicular to the side walls 24 of the base 20. The conductive terminal 32 is fixed on the first body part 312 and exposed at two ends of the first body part 312 to facilitate electrical connection with the bonding pad 202 inside the light strip main body 201. Preferably, two rows of spaced first body parts 312 are provided. The conductive terminals 32 are sheet-shaped and are laid on the lower surface of the first body part 312 and distributed on two sides of the second body part 313, so that the conductive terminals 32 can be inserted into the light strip main body 201 to make electrical contact with the bonding pads 202.

The recess 311 is disposed on the second body part 313. The second body part 313 intersects the first body part 312 in a cross shape, so that the conductive terminal 32 is exposed on both sides of the second body part 313 to electrically connect two adjacent light strips 200. A matching surface 314 is correspondingly disposed at the bottom edge of the second body part 313. Both the guiding surface 223 and the matching surface 314 are inclined surfaces. Thus, through cooperation between the guiding surface 223 and the matching surface 314, the second body part 313 can be guided to enter into the positioning grooves 221 and after passing over the limiting post 222, the limiting post 222 is limitedly accommodated in the recess 311. In this way, tight matching between the electrical connection structure 30 and the base 20 is realized, ensuring to keep electrical connection between the electrical connection structure 30 and the light strips 200.

In addition, in the present application, three first buckle parts 241 are provided, one of three first buckle parts 241 is located outer side of the positioning groove 221 and the limiting post 222. Therefore, when the base 20 and the cover part 10 are buckled, the second body part 313 can be clamped along the width direction of the light strip connector 100, i.e., the extending direction of the second body part 313, so that the electrical connection structure 30 is fixed in the base 20 more stably.

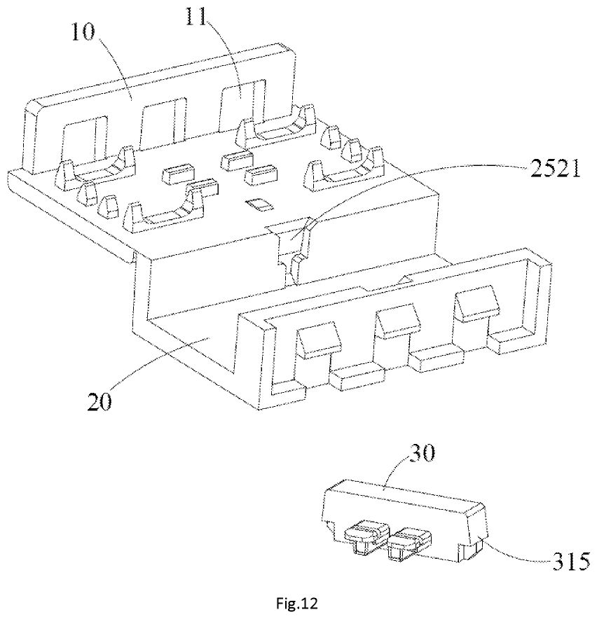

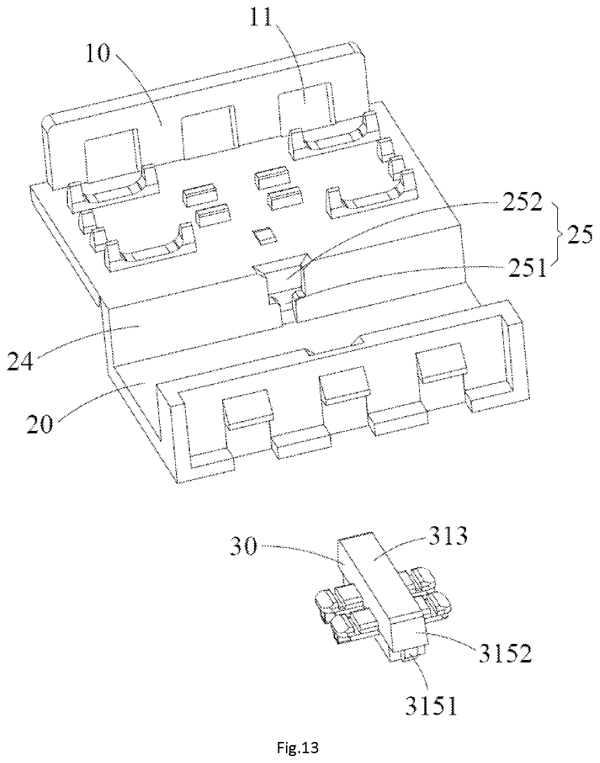

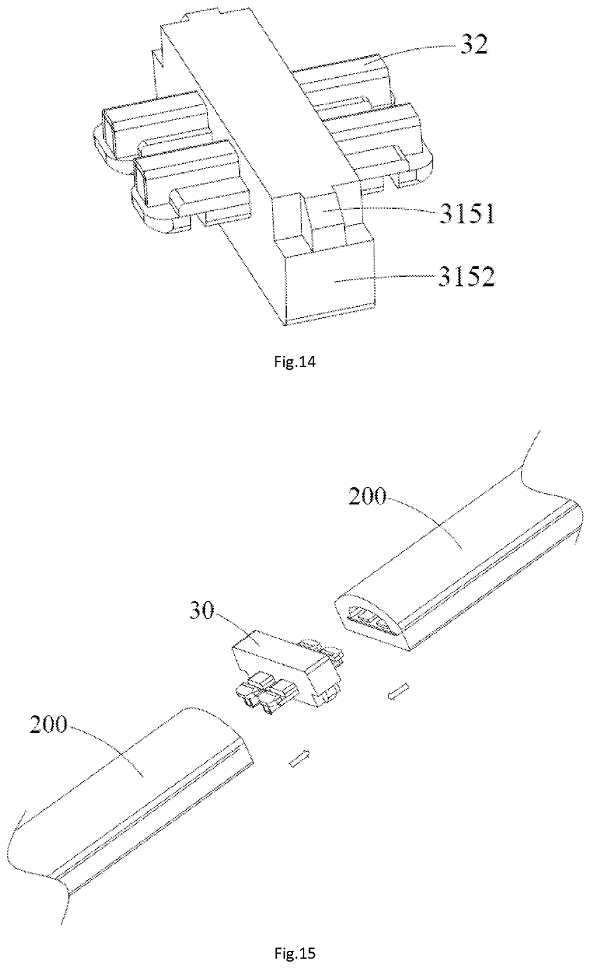

As shown in FIG. 11 to FIG. 14, in the second example of the present disclosure, the limiting part is a reverse inclined surface 2521 formed on the side wall 24, and the matching part is an inclined surface formed at an end of the body 31. When the electrical connection structure 30 is assembled into the base 20, the inclined surfaces and the reverse inclined surfaces 2521 are pressed against and attached each other to limit the electrical connection structure 30 along both the thickness direction and the width direction of the light strip connector 100. A fixing groove 25 is formed on the side wall 24 of the base 20. The reverse inclined surface 2521 is formed on a side of the fixing groove 25 close to the cover part 10 and inclines inward toward the side wall 24 along the thickness direction of the light strip connector 100.

Specifically, the fixing groove 25 is shaped as an inverted convex and includes a first fixing groove 251 close to the bottom wall 23 and a second fixing groove 252 close to the cover part 10. The first fixing groove 251 communicates with the second fixing groove 252, and the inner diameter of the second fixing groove 252 is larger than that of the first fixing groove 251. The reverse inclined surface 2521 is formed in the second fixing groove 252. An inverted convex bump 315 is disposed at the end of the second body part 313, including a first protrusion part 3151 close to the bottom wall 23 and a second protrusion part 3152 close to the cover part 10. The inclined surface refers to the outer wall surface of the second protrusion part 3152. Thus, when the electrical connection structure 30 is assembled into the base 20, the first protrusion part 3151 is accommodated in the first fixing groove 251, and the second protrusion part 3152 is accommodated in the second fixing groove 252. At this time, the inclined pressing force between the inclined surfaces and the reverse inclined surfaces 2521 can limit the second body part 313 in the base 20, ensuring sufficient positive electrical pressure when the conductive terminal 32 contact the light strips 200.

Similarly, three first buckle parts 241 are also provided, and one of the three first buckle parts 241 is disposed on outer side of the reverse inclined surface 2521. Thus, when the base 20 and the cover part 10 are buckled each other, the second body part 313 can be clamped along the width direction of the light strip connector 100, i.e., the extending direction of the second body part 313, so that the electrical connection structure 30 is fixed in the base 20 more stably.

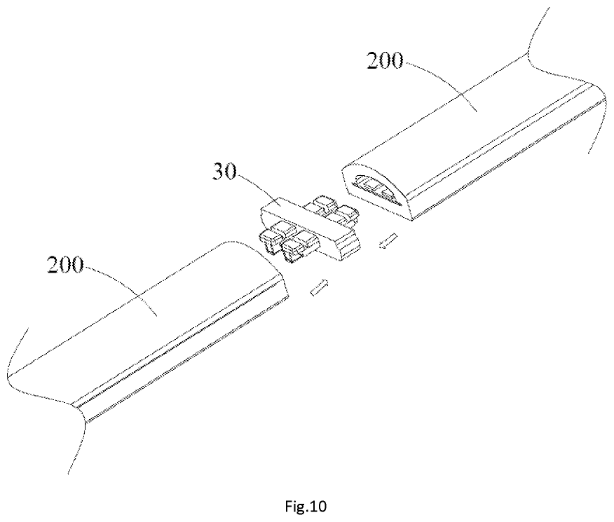

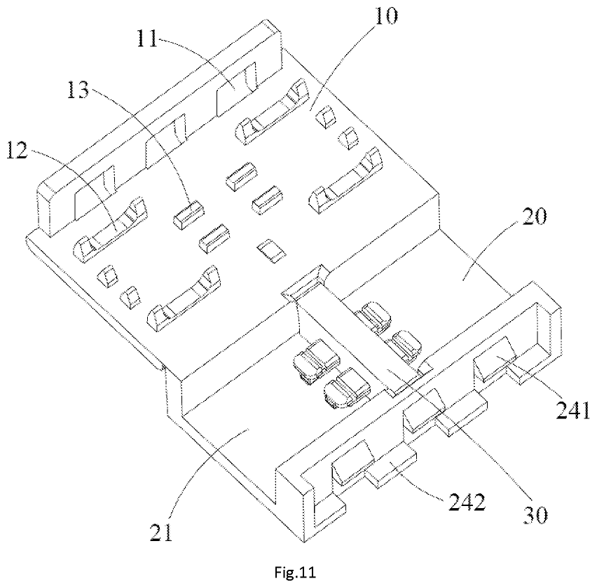

With reference to FIGS. 10 and 15 in combination with FIGS. 1 and 2, in assembling: first, inserting the electrical connection structure 30 into the light strips 200 on both sides respectively, making the conductive terminal 32 to form electrical connection with the bonding pad 202 in the accommodating space 203; then, assembling the whole of the electrical connection structure 30 and the light strips 200 into the base 20, and making tight matching between the electrical connection structure 30 and the base 20 through cooperation between the limiting part and the matching part; finally, flipping the cover part 10 to buckle and fix to the base 20 for secondary clamping and fixing of the light strips 200, and the assembling is completed.

In summary, in the light strip connector 100 of the present disclosure, limiting parts are provided on opposite side walls 24 of the base 20 and meanwhile, matching parts are correspondingly disposed on the body 31 of the electrical connection structure 30. Thus, through cooperation between the limiting parts and the matching parts, the electrical connection structure 30 is limited and fixed in the base 20 and tightly matched with the base 20 to realize electrical connection between the electrical connection structure 30 and the light strips 200. Compared with the prior art, the electrical connection between the electrical connection structure 30 and the light strips 200 will not be affected even if the cover part 10 loses clamping force, that is, the electrical pressure is no longer provided by buckling of the cover part 10, which significantly improves the reliability of electrical connection.

The purpose of the present disclosure is to provide a light strip connector. The electrical connection structure of the light strip connector is tightly matched with the base to establish electrical connection between the electrical connection structure and the light strip. Even if the cover part loses clamping force, the electrical connection remains unaffected, which greatly improves the reliability of electrical connection.

To achieve the above objective, the present disclosure provides a light strip connector for connecting light strips. The light strip connector includes a cover part, a base and an electrical connection structure. The cover part is connected to the base to form an accommodating space inside. The cover part and the base are capable of being movable to open the accommodating space, allowing the light strips to enter from both sides of the base, and the cover part and the base are capable of clamping the light strips therebetween. The electrical connection structure is accommodated within the accommodating space and includes a body and a conductive terminal. The conductive terminal is fixed on the body and exposed on two sides of the body to form electrical connection with the light strips entering from the both sides of the base. Opposite side walls of the base are provided with the limiting parts, and the body is correspondingly provided with matching parts. The limiting part is configured to cooperate with the matching part to limit and fix the electrical connection structure in the base at least along a thickness direction of the light strip connector.

Optionally, the body includes a first body part and a second body part perpendicular to each other. The second body part is disposed perpendicular to the side walls. The conductive terminal is fixed on the first body part and exposed at two ends of the first body part, and the matching parts are disposed on the second body part.

Optionally, the conductive terminal is sheet-shaped and laid on a lower surface of the first body part and disposed on two sides of the second body part. The light strip includes a light strip main body and a bonding pad fixed inside the light strip main body. The conductive terminal can be inserted into the light strip main body to be in electrical contact with the bonding pad.

Optionally, the limiting part includes a positioning groove formed on the side wall and a limiting post fixed in the positioning groove. The matching part is a recess disposed at a top edge of the body. When the electrical connection structure is assembled into the base, the limiting post is limitedly accommodated in the recess.

Optionally, the positioning groove is recessed inwardly on the side wall of the base, and the limiting post connects two opposite inner wall surfaces of the positioning groove.

Optionally, a guiding surface is formed on a side of the positioning groove close to the cover part, and a matching surface is correspondingly formed at a bottom edge of the body. Both the guiding surface and the matching surface are inclined surfaces, configured to guide the body into the positioning groove and allow the limiting post to be limitedly accommodated in the recess after passing over the limiting post.

Optionally, the limiting part is a reverse inclined surface disposed on the side wall, and the matching part is an inclined surface formed at an end of the body. When the electrical connection structure is assembled into the base, the inclined surface and the reverse inclined surface are pressed against and attached each other to limit the electrical connection structure along both the thickness direction and the width direction of the light strip connector.

Optionally, a fixing groove is disposed on the side wall, and the reverse inclined surface is formed on a side of the fixing groove close to the cover part and inclines inward toward the side wall along the thickness direction of the light strip connector.

Optionally, the fixing groove is shaped as an inverted convex and includes a first fixing groove close to the base and a second fixing groove close to the cover part. The reverse inclined surface is formed in the second fixing groove. An inverted convex bump is correspondingly disposed at the end of the body and includes a first protrusion part close to the base and a second protrusion part close to the cover part. The inclined surface is an outer wall surface of the second protrusion part. When the electrical connection structure is assembled into the base, the first protrusion part is accommodated in the first fixing groove, and the second protrusion part is accommodated in the second fixing groove.

Optionally, a plurality of first buckle parts are disposed on the outer wall surface of the base, at least one of the plurality of first buckle parts is located an outer side of the limiting part. A second buckle part is correspondingly disposed on the cover part. The first buckle parts cooperate with the second buckle part to buckle and fix the cover part to the base and clamp the body along the width direction of the light strip connector.

Beneficial Effects of the Invention: in the light strip connector of the present disclosure, the limiting parts are disposed on opposite side walls of the base and the matching part is corresponding disposed on the body of the electrical connection structure. Through cooperation between the limiting part and the matching part, the electrical connection structure is limited and fixed in the base, so that the electrical connection structure and the base are tightly matched each other, so as to realize electrical connection between the electrical connection structure and the light strip. Compared with the prior art, the electrical connection between the electrical connection structure and the light strip will not be affected even if the cover part loses clamping force, which significantly improves the reliability of electrical connection.

The above examples are only used to illustrate the technical solutions of the present disclosure rather than to limit them. Although the present disclosure has been described in detail with reference to examples, those skilled in the art shall understand that modifications or equivalent substitutions may be made to the technical solutions of the present disclosure without departing from the spirit and scope of the technical solutions of the present disclosure.

1. A light strip connector for connecting light strips, wherein the light strip connector comprises:
a cover part and a base, wherein the cover part is connected to the base to form an accommodating space; the cover part and the base are movable to open the accommodating space so as to allow the light strips to enter from two sides of the base, and the cover part and the base are capable of clamping the light strips therebetween;
an electrical connection structure, accommodated in the accommodating space, wherein the electrical connection structure comprises a body and a conductive terminal, the conductive terminal is fixed on the body and exposed on two sides of the body to form electrical connection with the light strips entering from the two sides of the base;
wherein limiting parts are disposed on opposite side walls of the base, matching parts are disposed on the body, and the limiting parts are configured to cooperate with the matching parts to limit and fix the electrical connection structure in the base at least along a thickness direction of the light strip connector.

2. The light strip connector according to claim 1, wherein the body comprises a first body part and a second body part perpendicular to each other; the second body part is disposed perpendicular to the side walls; the conductive terminal is fixed on the first body part and exposed at two ends of the first body part; and the matching parts are disposed on the second body part.

3. The light strip connector according to claim 2, wherein the conductive terminal is sheet-shaped, disposed on a lower surface of the first body part and distributed on two sides of the second body part; the light strip comprises a light strip main body and a bonding pad fixed inside the light strip main body; and the conductive terminal is capable of being inserted into the light strip main body to be in electrical contact with the bonding pad.

4. The light strip connector according to claim 1, wherein the limiting part comprises a positioning groove disposed on the side wall and a limiting post fixed in the positioning groove; the matching part is a recess disposed at a top edge of the body; and when the electrical connection structure is assembled into the base, the limiting post is limitedly accommodated in the recess.

5. The light strip connector according to claim 4, wherein the positioning groove is recessed inwardly on the side wall of the base, and the limiting post connects two opposite inner wall surfaces of the positioning groove.

6. The light strip connector according to claim 5, wherein a guiding surface is disposed on a side of the positioning groove close to the cover part; a matching surface is correspondingly disposed at a bottom edge of the body; both the guiding surface and the matching surface are inclined surfaces configured to guide the body into the positioning groove and allow the limiting post to be limitedly accommodated in the recess after passing over the limiting post.

7. The light strip connector according to claim 1, wherein the limiting part is a reverse inclined surface disposed on the side wall; the matching part is an inclined surface formed at an end of the body; and when the electrical connection structure is assembled into the base, the inclined surface and the reverse inclined surface are pressed against and attached each other to limit the electrical connection structure along both a thickness direction and a width direction of the light strip connector.

8. The light strip connector according to claim 7, wherein a fixing groove is disposed on the side wall; the reverse inclined surface is formed on a side of the fixing groove close to the cover part and increasingly inclines inward toward the side wall along the thickness direction of the light strip connector.

9. The light strip connector according to claim 8, wherein the fixing groove is shaped as an inverted convex and comprises a first fixing groove disposed close to the base and a second fixing groove disposed close to the cover part, and the reverse inclined surface is formed in the second fixing groove; an inverted convex bump is correspondingly disposed at an end of the body and comprises a first protrusion part disposed close to the base and a second protrusion part disposed close to the cover part; the inclined surface is an outer wall surface of the second protrusion part; when the electrical connection structure is assembled into the base, the first protrusion part is accommodated in the first fixing groove; and the second protrusion part is accommodated in the second fixing groove.

10. The light strip connector according to claim 1, wherein a first buckle part is disposed on an outer wall surface of the base, a plurality of first buckle parts are provided, at least one of the plurality of first buckle parts is located on an outer side of the limiting part; a second buckle part is correspondingly disposed on the cover part; the first buckle part cooperates with the second buckle part to buckle and fix the cover part and the base and clamp the body along a width direction of the light strip connector.

11. The light strip connector according to claim 1, wherein the limiting part and the matching part cooperate to maintain electrical contact between the conductive terminal and the light strip independently of a clamping force provided by the cover part.

12. The light strip connector according to claim 1, wherein the cover part and the base are connected through a rotating structure configured to rotate between an open position and a closed position.
